(19) United States
(12) Patent Application Publication
(10) Pub. No.: US 2005/0055379 A1
(43) Pub. Date: Mar. 10, 2005

(54) Information processing apparatus, method of processing information and server

(75) Inventors: Masahiro Yamazaki, Yokohama (JP); Yuzo Okano, Yokohama (JP); Hideki Kuwamoto, Fujisawa (JP)

Correspondence Address: McDermott, Will & Emery, 600, 13th Street, N.W., Washington, DC, 20005-3096, US

(73) Assignee: HITACHI, LTD.

(21) Appl. No.: 10/921,959

(22) Filed: Aug. 20, 2004

(30) Foreign Application Priority Data
Sep. 9, 2003 (JP) 2003-316176

(51) Int. Cl. G06F 7/00

(52) U.S. Cl. 707/104.1

(57) ABSTRACT

In a method for processing information, a database storing user data regarding individuals registered as users of an information transmitting or receiving service is maintained, and information from a first one of the registered users is received. Then, a second user of the registered users is selected based on the user data, and the received information is transmitted to the selected second one of the registered users.

This application claims the benefit of priority of Japanese Application No. 2003-316176 filed Sep. 9, 2003, the disclosure of which also is entirely incorporated herein by reference.

### TECHNICAL FIELD

The present subject matter relates to an information processing apparatus such as a cellular phone, a PHS (Personal Handy-phone System), a PDA (Personal Digital Assistant) or a laptop or handheld Personal Computer as well as to a server, an information-processing method adopted by the apparatus and software used in the apparatus.

### BACKGROUND

JP-A-2001-276436 discloses a method of easily making communications with many people through cyberpets as characters which find an e-pal by roaming the Net freely in the search of a third person.

However, to see benefits of the invention disclosed in the above-cited Patent Document, a destination as well as source needs to have software or a terminal which can handle the cyperpets as characters.

Further, although the invention disclosed in the noted Patent Document is advantageous in that communication with a nonspecified person can be easily made by employing cyberpets as characters, protection of privacy is not so sufficiently considered that a source address is in danger of unnecessarily being notified.

There is a need for an improved method of processing information and an improved information processing apparatus.

### SUMMARY

The above stated need is met by the following method. In this method, a database storing user data regarding individuals registered as users of an information transmitting or receiving service is maintained, and information from a first one of the registered users is received. Then, a second user of the registered users is selected based on the user data, and the received information is transmitted to the selected second one of the registered users.

### BRIEF DESCRIPTION OF THE INVENTION

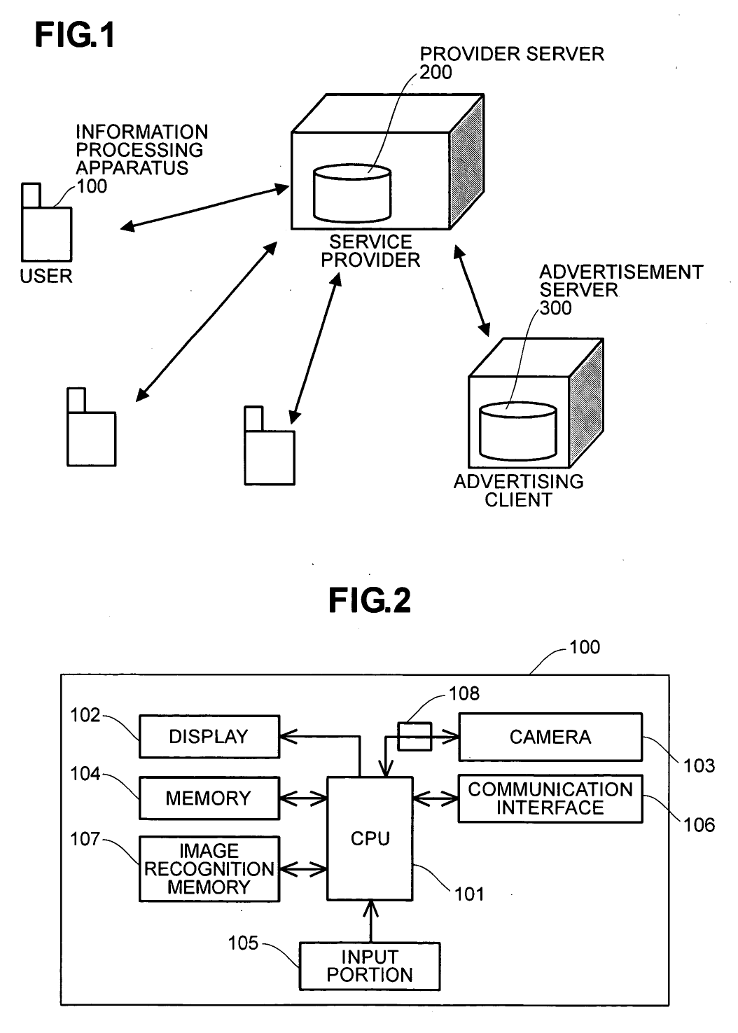

FIG. 1 is an overall system view of an information transmitting/receiving system.

FIG. 2 is a block diagram of an information processing apparatus.

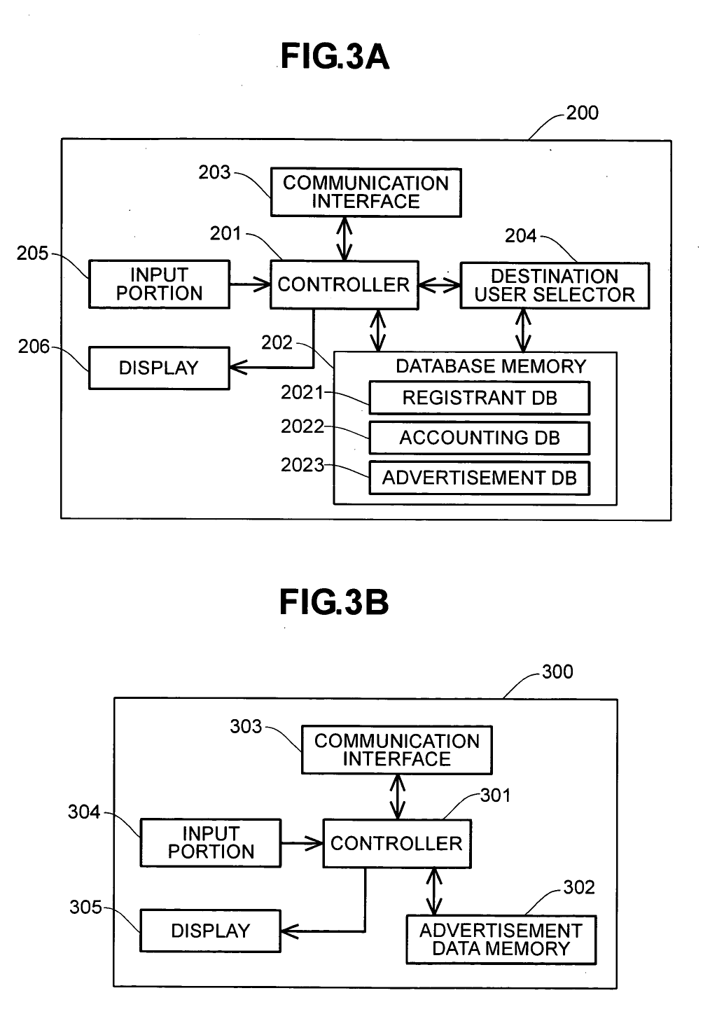

FIG. 3A is a block diagram of a provider server and FIG. 3B is a block diagram of the advertisement server.

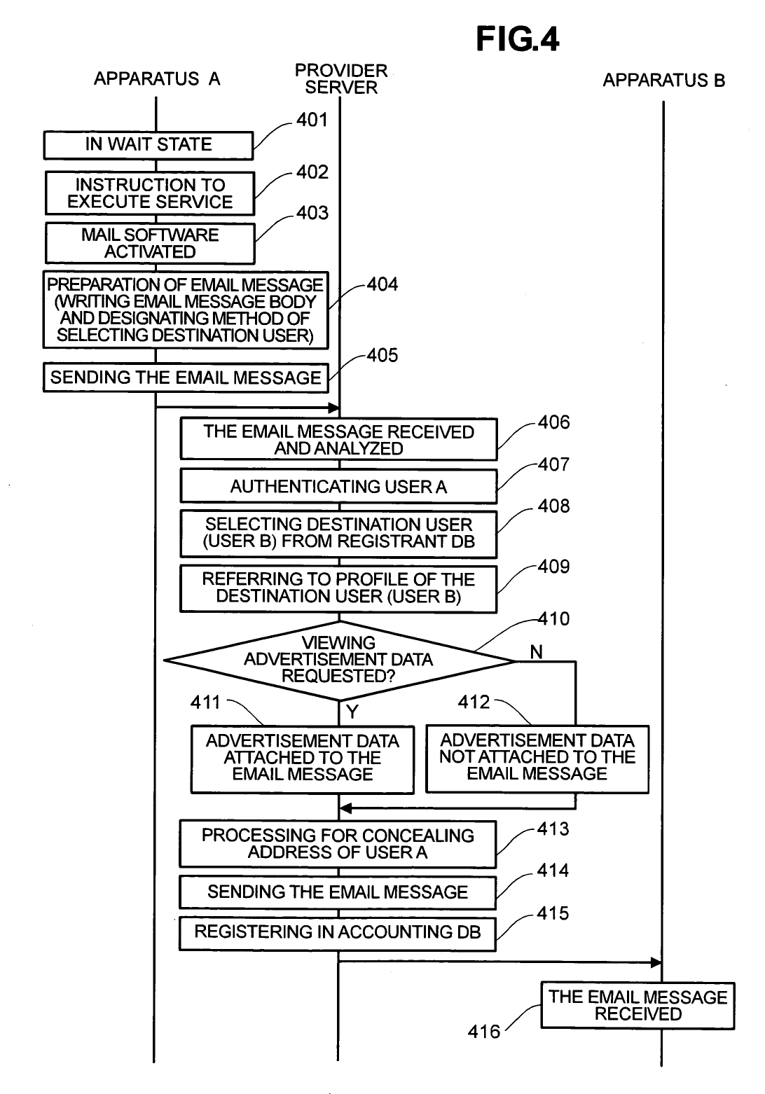

FIG. 4 is a flowchart illustrating a sequence of information transmitting/receiving operations of the system of FIG. 1.

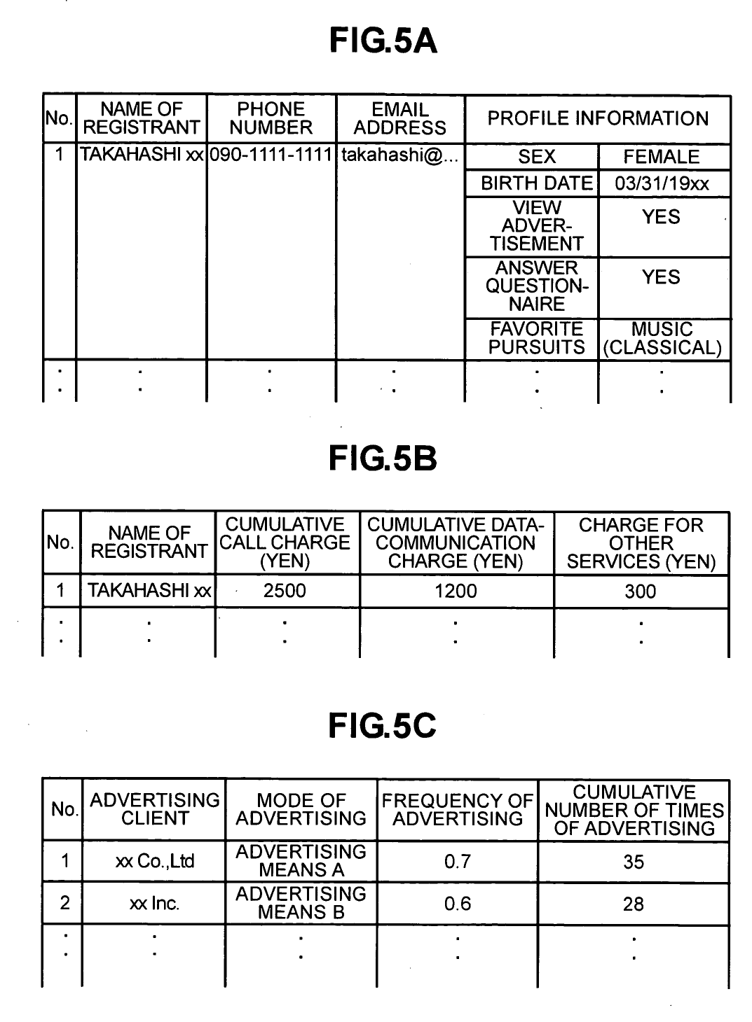

FIG. 5A is an example of the registrant database, FIG. 5B is an example of accounting database, and FIG. 5C is an example of the advertisement database.

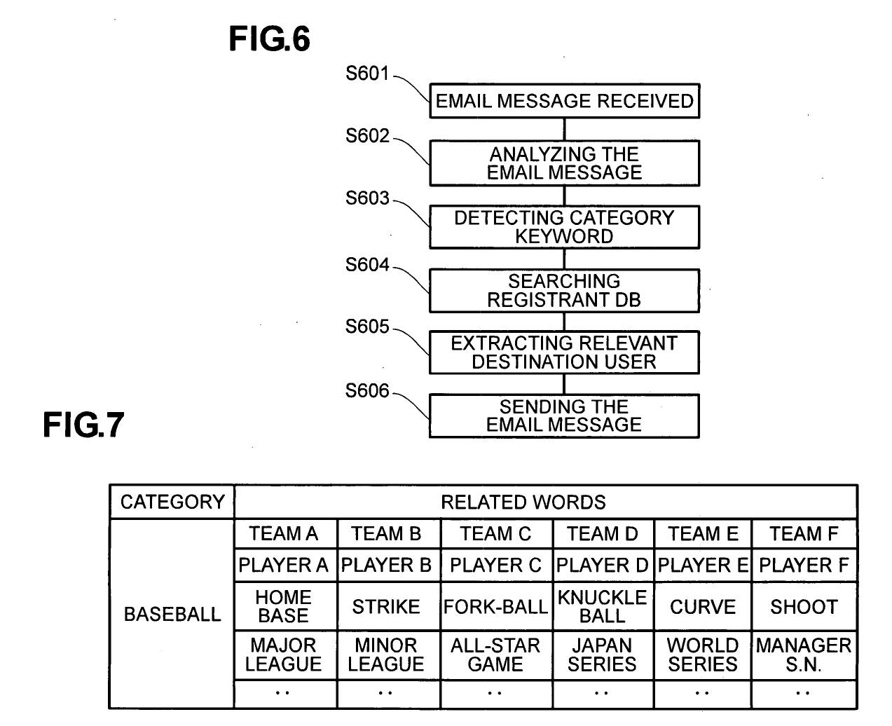

FIG. 6 is a flowchart of a process for specifying a destination user.

FIG. 7 shows an example of a directory of categories.

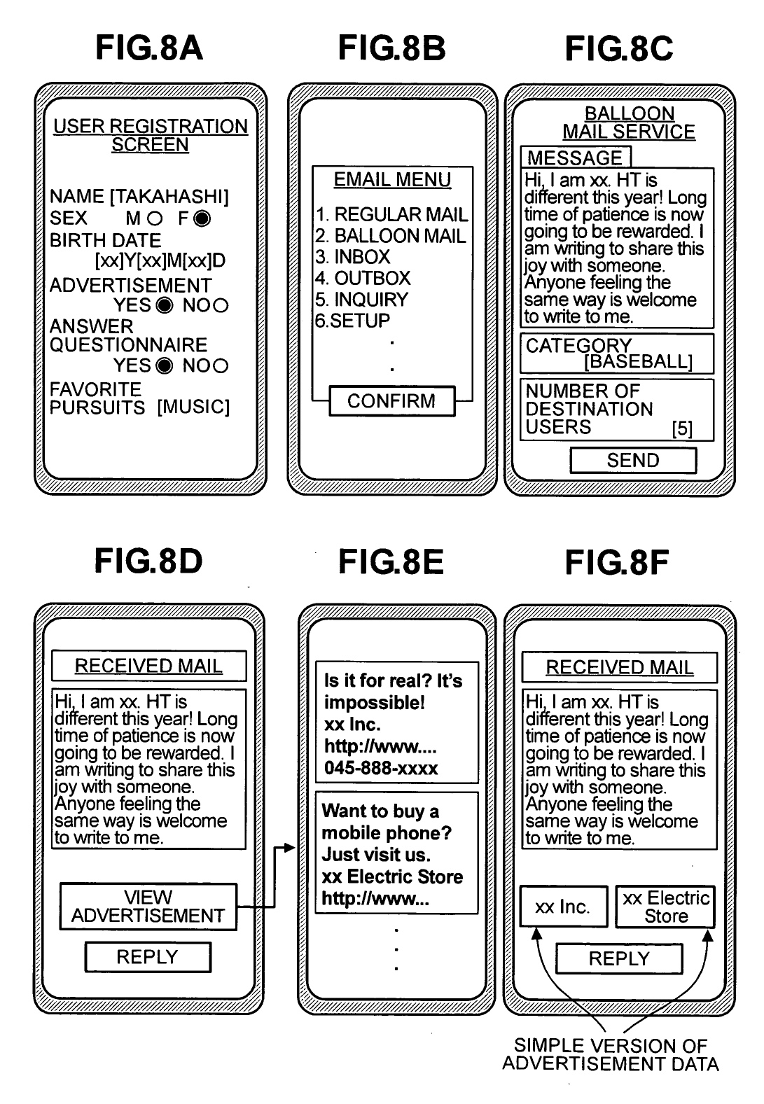

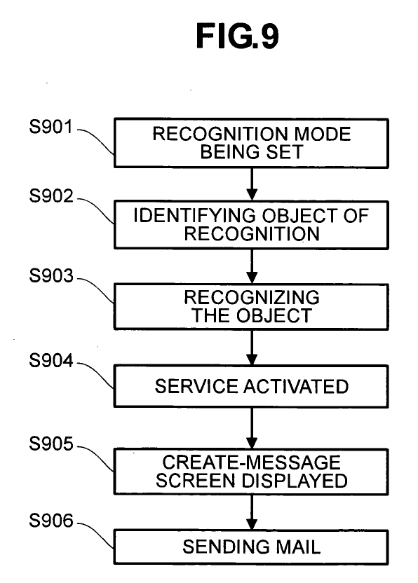

FIG. 8 (consisting of 8A to 8F) shows an example of display screens of the information processing apparatus.

FIG. 9 shows a flowchart of processing performed by an information processing apparatus.

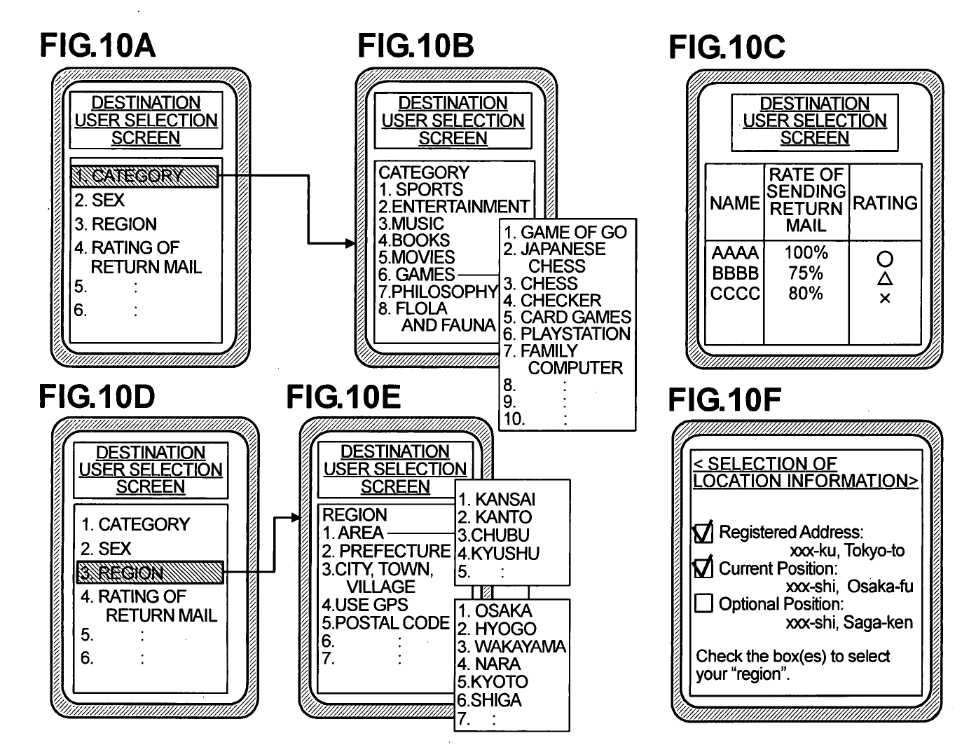

FIG. 10 (consisting of 10A to 10B) shows an example of display screens of the information processing apparatus when a user wishes to select a destination user.

### DETAILED DESCRIPTION

Examples of an information transmitting/receiving system will be described hereinafter with reference to drawings. In the drawings, the same reference numerals are used to refer to respective identical elements.

FIG. 1 is a schematic view of an information transmitting/receiving system. The system includes an information processing apparatus 100, a provider server 200 of a service provider and an advertisement server 300 of an advertising client who requests the service provider to take out an advertisement. In this system, users of information processing apparatus register as users of the information transmitting/receiving service. The provider server 200 maintains a database storing data regarding registered users. The stored user data may include various demographic data about each users, and the server stores contact information to enable it to send message to each user. When the provider server 200 receives information from a first one of the registered users, the server 200 selects a second user from among the registered users based on the database and transmits the received information to the selected second one of the registered users. If necessary, the provider server 200 acquires an advertisement data from the advertising server 300 and transmits the advertisement data to the selected second user with the received information.

The information processing apparatus 100 may be a cellular phone, a PHS, a PDA, a laptop or handheld personal computer, or the like.

FIG. 2 is a block diagram of the information processing apparatus. A CPU 101 operates on the basis of a program (e.g., mail software) stored in a memory 104 to control each component of the information processing apparatus 100 in accordance with an input from an input portion 105, for example.

A display 102 may consist of a LCD (Liquid Crystal Display) or an organic EL (Electroluminescence) display, and displays information such as an image taken by a camera 103 and textual information recognized by the CPU 101. The display 102 further indicates, for example: power on/off state, radio field intensity, battery power, server connection state, operational state (e.g., unread message), phone number inputted, email destination, email message, received data (e.g., dynamic and static image, phone number of caller when an incoming call arrives, email message received, screen as connected to the Internet), and screen necessary for the user to use each function of the information processing apparatus 100.

The camera 103 converts an image of an object such as a human face, landscape and text or characters into an image data. The image data is inputted into the CPU 101 via a picture interface 108. The image of the object may be converted into any form of image data as long as the image data can be handled by the CPU 101. The user selects an image to be taken from monitored image data outputted to the display 102, and indicates the timing of taking the image by manipulating the input portion 105 such as a shutter button. Upon manipulating the input portion 105, the taken image data is stored in the memory 104. In this example, the camera 103 is built in the information processing apparatus. This invention is not limited to this example. The camera may be external and attached to the information processing apparatus through the picture interface 108.

The memory 104 may consist of an ROM (Read Only Memory) or RAM (Random Access Memory), and stores data handled in the information processing apparatus 100 and software such as a mail soft, for example. The input portion 105 may consist of a keyboard or touch panel, and is an input portion through which a phone number and other information is inputted, and which is used when the user gives an input into the information processing apparatus100, for example, when the information processing apparatus 100 is powered on/off and when an image of the object is taken.

A communication interface 106 performs communication with a server or a host computer of an information provider or any other device via a network. It is also possible to provide a plurality of communication interface instead of using only one as shown in FIG. 2. In this case, a user may use a plurality of communication methods such as CDMA, EV-DO, wireless LAN. A image recognition memory 107 stores a software program to be executed for an OCR (Optical Character Recognition) function by the CPU 101. The OCR function will be described later.

FIG. 3A is a block diagram of a provider server 200. A controller 201 controls components of the server 200. A database memory 202 stores various databases. The databases include a registrant database (which will be referred to as “registrant DB”) 2021 which is a database of information related to a user of the service, an accounting database (which will be referred to as “accounting DB”) 2022 which is a database of information related to accounting, and an advertising database (which will be referred to as “advertisement DB”) 2023 which is a database of information related to advertising. An example of each of the databases will be described later.

A communication interface 203 executes communication with the information processing apparatus or other device via a network.

A destination-user selector 204 operates to select a destination user to which information such as an email message is forwarded, based on a data received through the communication interface 203 and a data stored in the database memory 202. An input portion 205 accepts user inputs from the outside, while a display 206 shows various data. The input portion 205 and display 206 are used when the database memory 202 is organized, for instance. Although shown as a separate element in FIG. 3A, the function of the destination user selector 204 usually is implemented as software run on the controller 201. Hence, the controller 201 is usually adapted to implement the processing performed by the destination-user selector 204.

FIG. 3B is a block diagram of the advertisement server 300, which supplies the server 200 with a data representative of an advertisement (hereinafter simply referred to as “advertisement data”) which is desired to be publicized when the service is rendered. The server 300 comprises a controller 301, an advertisement data memory 302, a communication interface 303, an input portion 304 and a display 305.

The controller 301 controls the components of the server 300. The advertisement data memory 302 stores advertisement data including an advertising copy for merchandise, company or others, and contract data related to a contract with the service provider. The input portion 304 accepts user inputs from the outside, while the display 305 shows various data. The input portion 304 and display 305 are used when the advertisement data stored in the advertisement data memory 302 is organized, for instance.

In this example, the provider servers 200 and the advertisement server 300 are provided separately. However, it may be arranged such that the server 200 incorporates the advertisement data memory 302. In this arrangement, burden on the advertising client (server 300) regarding required equipment is reduced, as well as modification or adjustment of the advertisement data can be efficiently implemented since the service provider overall controls the advertisement data.

Next, an exemplary service will be described. According to this service, for instance, when the user has been impressed by a book and desires to talk about it at once to a person regardless of who the person is, the user may communicate with one or more strangers, by a simple operation.

However, when the user sends and receives messages to and from unknown persons, the user may receive a prank mail or may be involved in a crime of some sort. Therefore, the service is such that personal information including users email address is not exchanged between users.

Thus, an object of this service is to enable users to send and receive messages to and from each other, not only between users who know each other, but also between users who are unknown to each other, so that the users can feel the joy of getting to know each other or enjoy an unexpected reaction to a message from an unknown person, without anxiety. The present service will be hereinafter referred to as “balloon mail (service)”.

There will next be described a determination made by the service provider when forwarding an email message as to whether an advertisement is attached to the email message or not. In this example, the email message is transmitted to the user. However, this invention is not limited to this example. Other data may be transmitted.

There will be described processing implemented by the provider server 200. FIG. 4 is a flowchart illustrating the service rendered in a case where a user A sends an email message to a user B, with the processing implemented by the server 200 being centered. Information processing apparatus A is a information processing apparatus owned by user A, while information processing apparatus B is a information processing apparatus owned by user B. The user A and the user B have registered as users of this information transmitting/receiving service, and their information has been stored in the registrant DB 2021 already.

While the information processing apparatus A is held in a wait state where an incoming call or a data such as an email message is ready to be received, an execution of the service is instructed by user A (steps 401, 402) and thereby a service-execution command signal is input into the CPU 101 of the information processing apparatus A. The CPU 101 then activates a mail software stored in the memory 104 (step 403). Upon the activation of the mail software, a screen for creating a new email message is shown on the display 102, and user A creates an email message through this screen (step 404).

When an email message is created, the user enters a message body (such as subject line and text) and designates a method of selecting a destination user, through the input portion 105, for instance. There will be described a case where user A designates a method according to which the destination user is randomly selected, or a “random selection method”.

Once it is instructed to forward the email message by user A, an email data including a data of the message body and a data representative of designation of the random selection method is sent to the server 200 by the CPU 101 and communication interface 106 (step 405).

The server 200 receives the email data, and then analyzes the email data to certify whether user A is a regular registrant based on the registrant DB 2021 (steps 406, 407). This certification may be implemented based on a source address or an email address of user A. In a case where user A is determined not to be a regular registrant as a result of the certification, the controller 201 of the server 200 transmits to the information processing apparatus A an error message indicating that user A is not a registrant for the service, or a message inviting user A to register for the service. On the other hand, where user A is a regular registrant, a destination user is selected from the registrants stored in the registrant DB 2021, in accordance with the data representative of designation of the random selection method, and the processing is continued (step 408). In this specific example, user B is solely selected as a result of a random selection.

The controller 201 refers to profile information of user B stored in the registrant DB 2021 (step 409). The controller 201 determines whether user B requests to view advertisement data (step 410). Where user B requests to view advertisement data, an advertisement data stored in the advertisement DB is attached to the received email message and the cumulative number of times of advertising is updated (step 411). Where user B does not request to view advertisement data, an advertisement data is not attached to the received email message (step 412). Then, the controller 201 forwards the email message to user B, with the email address of user A replaced with another address, e.g., an email address which represents the service (step.413). User B receives the email message forwarded from the server 200.

Thus, according to the first embodiment where the email address of user A is replaced with another address when forwarding the email message, privacy of a sender is protected.

The way to conceal the email address of user A is not limited to the one described above.

After forwarding the email message, the server 200 implements accounting processing in accordance with an amount of data communication (amount of packets) with respect to the email data. In this accounting processing, where it has been determined that user B requests to view advertisement data in step 410, a predetermined discount may be applied and registered in the accounting DB as such, or, it may be treated such that the service is rendered free of charge. On the other hand, where it has been determined that user B does not request to view advertisement data, an ordinary charge is registered in the accounting DB as a charge for the service. Although the email message is forwarded to a sole destination user in the above example, the email message may be forwarded to a plurality of destination users.

In the example shown in FIG. 4, a case where user A sends the email message to user B is illustrated. However, even where user B sends a return email to user A, the server 200 determines whether user A requests to view advertisement data or not, and an advertisement data is sent to user A via the server 200 only where it is determined that user A requests to view advertisement data. Further, processing of replacing an email address of user B for concealing the email address of user B, similar to the processing in step 413 is performed.

According to the above-described arrangement, since email addresses of users or registrants are processed so that the respective email addresses are concealed from each other, the users or registrants can send and receive to and from an unknown person and enjoy an unexpected reaction to an email message from an unknown person, without anxiety.

As described above, by using a information processing apparatus which is most commonly always carried by a user, the service according to the first embodiment of the invention enables a user to casually communicate with others anywhere at any time, for instance, during a breathing space such as a recess between meetings and a travel time on a train or others.

Further, according to the service, where a user views advertisement data, the service can be enjoyed with a relatively low charge or free of charge.

Still further, according to the service, the server implements most parts of the required processing, and the user thereby need not have a special terminal or exclusive software and the like for the service. Hence, the service is not exclusive to communications between terminals on which exclusive software or the like is mounted, and is easily available for users.

There will be described processing implemented when the advertising client supplies the service provider an advertisement data. The advertising client gives an instruction to the controller 301 to transmit the advertisement data to the server 200, through the input portion 304 or others. The controller 301 receives the instruction, and extracts the advertisement data from the advertisement data memory 302 in accordance with the input and then transmits the advertisement data to the server 200.

The server 200 receives the advertisement data, and stores the advertisement data as an additional data in the advertisement DB 2023 or updates a corresponding data in the advertisement DB 2023.

This arrangement facilitates an upgrade and replacement of an advertisement by the advertising client. For the service provider, the arrangement is advantageous in that it is easy to attach an advertisement when the service is performed, while earning the charge for the advertising. Thus, an inexpensive service acquiring the increased number of customers can be provided.

There will be described a specific example of each of the databases stored in the database memory 202 of the server 200, by reference to FIG. 5.

FIG. 5A shows one example of the registrant DB 2021 which includes a name, a phone number, a network address such as an email address, and profile information of each registrant, for example. The “profile information” represents demographic information about each registered user other than the user's identification information such as a network address or the like. The profile information may include sex, birth date, whether to “view advertisement” or not, whether to answer a given questionnaire or not (item “answer questionnaire”), and favorite pursuits of the registrant, as shown in FIG. 5A. In another example(not shown), the profile information may include user location data. The user location data may include a predefined home location and/or current location data. However, information stored in the registrant DB 2021 is not limited to these examples.

The “favorite pursuits” represents something related to a field each user is interested in or at home with, such as baseball, cooking and classical music.

A registered user whose profile information indicates that the user will “answer questionnaire” receives the given questionnaire along with an email data originating at the sender. In this case, processing similar to the above-described example shown in FIG. 4 is performed. In this regard, the attached data is a “questionnaire data” instead of the advertisement data, in the present case. A questionnaire client can collect responses to the given questionnaire in the form of email data from a wide range of users without fail, by utilizing an email functionality of a mobile phone or the like.

It may be arranged such that when a user responds to the questionnaire, the server 200 automatically adds data representative of sex and birth date of the user to the response and forwards the response to the questionnaire client, if the user permitted the server to send such demographic data previously. In this arrangement, the user need not bother to input these information, while the questionnaire client can easily obtain personal information of target of the questionnaire.

Data of the registrant DB 2021 as described above may be inputted by the service provider through the input portion 205. Alternatively, the controller 201 may receive a registrant data file via the communication interface 203, and add data to the registrant DB 2021 or update the relevant existing data.

FIG. 5B shows one example of accounting DB, which comprises, for example, name of registrant, cumulative call charge indicating a total charge for calls to date, cumulative data-communication charge, and charge for other services which is a total amount of charges for various services received.

FIG. 5C shows one example of the advertisement DB which comprises, for example, name of advertising client, mode of advertising, frequency of advertising, and cumulative number of times of advertising. Advertising client may be a company which desires to advertise. The “mode of advertising” indicates means for indicating an advertisement data, and may be represented by text data or audio data. The “frequency of advertising” represents a frequency of the advertisement data being transmitted to information processing apparatuss or others. For instance, in a case where the frequency of advertising is 0.7, the advertisement data is selectively shown to users seven times out of ten times; i.e., the higher the frequency is, the higher the probability that the advertisement data is transmitted to the information processing apparatuss or others. The frequency is determined depending upon an advertising charge paid by the advertising client to the service provider.

The advertisement data may be transmitted to the destination user without assigning a weight to the frequency of attaching the advertisement.

The “cumulative number of times of advertising” represents the number of times the server 200 has transmitted the advertisement data. The cumulative number of times of advertising may be replaced by cumulative number of persons to which the advertisement data has been transmitted.

In the above description, the user designates a method of selecting the destination user and instructs the server to select the destination user accordingly. However, the way of selecting a method according to which the destination user is selected is not limited to this, but may be such that the server reads the content of the email data and automatically selects the method.

Then, there will be described how the server 200 determines the destination user based on an item “favorite pursuits” of the registrants, by reference to a flowchart of FIG. 6.

For instance, a user sends an email message which reads: “I want to know about player A of major league”. The server 200 receives the email message and analyzes the email message (steps 601, 602). More specifically, inference processing is performed such that category keyword “baseball” is deduced from the words “major league” and “player A” on the basis of directory of categories stored in the database memory 202 in advance (step 603). Then, registrants whose profile information indicates that their favorite pursuits are “baseball” are searched from the registrant DB 2201 (step 604), to extract the destination user (step 605). The “directory of categories” refers to a dictionary data storing words related to each of categories. FIG. 7 shows the content of the category “baseball” in the directory of categories. Then, the controller 201 sends the email message to the extracted destination user (step 606).

As described above, the destination user is selected on the basis of the favorite pursuits of the registrants stored in the registrant DB 2021, a probability that the user who has sent the email message receives a return email is enhanced, as well as the user receiving the email message can smoothly communicate since the email message is about his/her favorite pursuits.

Although in this specific example, the server 200 searches the directory of categories to identify the relevant category, it may be arranged such that the user specifies category of the content of an email message when to send the email message. According to this arrangement, the directory of categories and the inference processing using the directory can be omitted, thereby enabling efficient utilization of memory capacity of the server 200 as well as reducing processing load on the CPU.

FIG. 8 shows an example of display screens of an information processing apparatus. FIG. 8A shows an example of a screen through which a user registers him/herself into the registrant DB 2021. In this example, items to be registered are: name, sex, birth date, whether to “view advertisement” or not, whether to “answer questionnaire” or not, and favorite pursuits. However, the items are not limited to these. FIG. 8B shows an example of a selection screen for implementing the service.

FIG. 8C shows an example of a display screen when to send an email message by using the balloon email service. The user may designate a category and number of destination users. It may be arranged such that in fields for respectively designating the category and number of destination users, the category and number of destination users as designated and stored in the memory 104 when the user has sent an email message using the balloon email service the last time, are displayed. Thus, the user may refer to a record of previously sent email messages, thereby making the balloon email service convenient.

The category and number of destination users may be inputted by way of a pulldown menu and through the input portion 105, or may be inputted by operating a given operating key.

FIG. 8D shows an example of display screen showing an email message received through the balloon email service. In this specific case, an advertisement is attached to the received message, and in a case where viewing the advertisement is chosen, advertising screen as shown in FIG. 8E is displayed.

Although a case where the message body of the email message and the advertisement data are displayed on respective screens as shown in FIGS. 8D and 8E is described above, the advertisement data may be displayed in the same screen where the message body is displayed. In this case, size of characters of text data of the advertisement data may be reduced and the advertisement data may be shown with using icons or others so as to be easily viewable, where appropriate when considering a size of the screen of the information processing apparatus.

It may be adapted such that an advertisement data representative of a detailed version of the advertisement may be displayed when a given icon or the advertisement shown in a reduced size is chosen. FIG. 8F shows an example of display screen in such a case. In this case, the server 200 stores the advertisement DB 2023 with a data representative of a simple version of the advertisement (hereinafter referred to as “simple version of the advertisement data”) being associated with a data representative of detailed information on the advertisement (hereinafter referred to as “detailed version of the advertisement data”).

When the message body of an email message is displayed, the simple version of the advertisement data is shown in a location not to interfere with viewing the message body; in a case where the user inputs an instruction to display the detailed version of the advertisement data through the input portion 105, the detailed version of the advertisement data stored in the advertisement DB 2023 is received via the communication interface 103. The detailed advertisement is displayed on the display 102. Accordingly, the user first views a simplified advertisement, and then may refer to details of the advertisement when the user feels interested in the advertisement.

The server 200 may select an advertisement data based on the profile information stored in the registrant DB 2021. For instance, in a case where profile information of a user as a destination user indicates that one of the user's favorite pursuits is music, the server 200 extracts advertisement data related to music from the advertisement DB 2023 and transmits the extracted data to the destination user. In this case, advertisement data is stored in the advertisement DB 2023 with being associated with respective categories. In a case where no advertisement data corresponding to the favorite pursuits in question is found, the server 200 randomly selects an advertisement data in another category from the advertisement DB 2023 and transmits the selected data.

According to the above-described arrangement, since an advertisement data fitted to favorite pursuits of each registered user can be transmitted, a probability that the advertisement is viewed by the user is improved, making the service an effective way of advertising for the advertising client. The arrangement is advantageous for the user also in that the user can view an advertisement of a field in which he/she is interested.

It is noted that although FIG. 2 shows a case where a camera 103 and image recognizer 107 are incorporated in the information processing apparatus, these elements may be omitted.

Next, a service using an information processing apparatus with an OCR (Optical Character Recognition) function will be described. More specifically, a string of one or more characters such as a word or a symbol is recognizedThe user of this service may receive information related to the recognized character string using the information processing apparatus. The related information includes, for example, meaning of the words or symbols, comments and remarks of an other person such as other user of the service. The server 200 may perform the processing for concealing the email addresses of the users from each other so that the users can without anxiety send and receive email messages to and from an unknown person. The structures of the information processing apparatus and server 200 are the same as those shown in FIGS. 2 and 3.

The OCR function is a function to recognize character including a letter, a sign, a symbol, a mark, a number, and identification information or the like included in a picture. The identification information is, for example, an address of a home page, an email address, a post address, a telephone number, or map information. The identification information is not limited to these examples but may be any information with which an entity can be identified The recognition of a string of one or more characters comprises the steps of identifying a place that includes string of one or more characters from a picture taken by the camera 103, dividing the image data for the portion containing characters into predetermined portions, converting each of the data for the portions into a parameter value and determining what information is included in each of the portions on the basis of the parameter value.

As an example, recognition of characters ‘abc’ included in a picture is explained. First of all, the place at which the characters ‘abc’ are included in the picture is identified. Then, the image data for the portion containing characters ‘abc’ are split into portions containing characters ‘a’, ‘b’ and ‘c’. The data for portions contains characters ‘a’, ‘b’ and ‘c’ are converted into respective parameter values. For example, the character “a” is parameterized in terms of structure of its line segments which extend in respective directions (vertical, horizontal and oblique), such that a white or blank point of the character is assigned value 0 while a black point of the character is assigned value 1. Then, a character having a parametric value which most resembles the thus obtained parametric value is selected from a character pattern data table, which is a table of parametric values and respectively corresponding characters such as alphabetical letters and is stored in the memory 104.

In this example, a memory dedicated for a character recognition software is provided as the picture recognition memory 105. As an alternative, picture-processing software may be embedded in the CPU 102 or the memory 104 to provide the CPU 101 with an OCR function. By embedding the picture-processing software in the CPU 102 or the memory 104, the number of components may be reduced and the manufacturing cost and the like may also be decreased as well.

In this example, in order to shrink the circuit scale, the CPU 101 executes the OCR function. However, the configuration of the present invention is not limited to this example. For example, a dedicated processor can be used for implementing the OCR function.

The CPU 101 determines by using a mode determination flag whether an imaging mode currently established is a regular mode for taking a common static or moving image or a recognizing mode for recognizing a string of one or more characters. The mode determination flag may be a variable present in a program included in software stored in the memory 104, and be differentiated depending upon the established imaging mode; and the CPU 101 switches the imaging mode between the regular mode and the recognizing mode in accordance with the variable. For instance, the flag is switched in response to operation of the input portion 105. In this second embodiment, the imaging mode comprises two modes, namely, the regular mode and the recognizing mode. However, the imaging mode is not limited to these modes but may comprise other modes.

A flow of processing performed by an information processing apparatus is shown in FIG. 9. First, the CPU 101, which has received an instruction to shift the imaging mode to the recognizing mode, sets the recognizing mode (step 901) and then identifies a word as an object to be recognized (step 902).

For instance, in a case where the word as the object to be recognized is “Icarus”, the user designates the part “Icarus” through the input portion 105, namely, by placing a cursor appropriately, for example. It may be adapted such that in a case where the word as the object to be recognized is an English word in English text, “+” symbol which is originally indicated at the center of the screen of the display 102 is moved onto the recognition information, and a portion around the “+” symbol as defined between first space information nearest the “+” symbol and second space information nearest the “+” symbol in the direction opposite to the first space information is automatically identified as one word. In a case where recognition information is specified in a moving image, it may be adapted such that each moving image can be played in single frame steps and an object to be recognized is selected in a desired still frame image.

In this specific example, the CPU 101 implements processing to encircle with a broken line the word “Icarus” as the object to be recognized, so that the user easily locates the object in the taken image data. In this regard, an image editor may generate an enlarged or diminished image of the word “Icarus” as the object to be recognized, and the enlarged or diminished image may be displayed. To enlarge the image, a pixel displayed as one pixel (1×1 pixel) is displayed with 2×2 pixels instead. Further, the image editor may convert the image of the characters as the object to be recognized into a black and white image or into a sepia-tone image, or may generate a modified image where black pixels are turned white and vice versa, so that each of these converted or generated images is displayed. The converted or generated images are not limited to those indicated above, but may be otherwise, as long as the object to be recognized is made clearly distinguishable in the image.

Once the object to be recognized is identified, the CPU 101 performs processing of recognizing the recognition information (step 903). When execution of the present service is automatically or manually instructed, the CPU 101 operates to display a create-message screen for creating an email message on the display 102 (step 905). In this example, the create-message screen contains an address field for inputting an email address of a destination user, a subject field for inputting a subject line of the email message, a message field where a message body of the email message is entered, and attachment field for attaching an image file or others. In the step 905, the CPU 101 automatically inserts the result obtained through the recognition processing. Accordingly, the user need not bother to copy and paste or other operations.

In the above-described example, the result obtained through the recognition processing (e.g., “Icarus”) is automatically inserted in the message field. However, the user may enter comments or others through the input portion 105. This arrangement facilitates entering a text, e.g., an asking sentence “What is Icarus at all?”, which is added after the “Icarus” which is the result of the recognition processing. In this case, the result and the text added (which may include an illustration and a pictogram) are displayed in respective colors, or in such a manner that only the result is underlined, or that sizes of characters of the result and the text are different, so that the result and the text are distinguishable.

The processing implemented by the server 200 is the same as that described above, and description thereof is omitted here.

Then, the CPU 101 receives a signal instructing it to send the email message and operates to send the email message through the communication interface 106 (step 906).

By utilizing the character recognition function, the user can avoid the trouble of inputting characters. This arrangement is particularly effective in such a case where the user notices an interesting word, while the user reads an article in a magazine or newspaper or happens to walk down in the street, and desires to instantaneously communicate detailed information on the word to someone.

When using the service described above, a sender user casually sends out an email message, while a recipient user may feel bothersome and may not send a return email, since the sender can be an unknown person to the recipient. In such a case, it is inevitable that the sender having taken the trouble to send the email message feels disappointed at not receiving a return email. Therefore, it is a considerably important object to arrange an environment where the recipient can easily send a return email.

Then, there will be described a method and a system for making it easy for the recipient to send a return email.

First, an arrangement where a recipient who sends a return email obtains a benefit that the data-communication charge is discounted. When a recipient replies to the received email message through the present service, the server 200 stores a reply history indicative of the fact, and implements processing such that the cumulative data-communication charge stored in the accounting DB 2022 is discounted by a given amount, in accordance with the replay history. Alternatively, it may be adapted such that if a user sends a return email once, a charge for sending email messages for the next five times is not required, or a data-communication charge is discounted by 200 yen. Thus discounting the data-communication charge can be an incentive to send a return email.

There will next be described another arrangement where a recipient who sends a return email obtains a benefit of obtaining a lottery data which gives a chance to receive a gift or others by lot. In this arrangement, the recipient sending a return email receives the lottery data from the server 200, and can participate in a lottery for a given gift or others based on the received lottery data. The way of holding the lottery may be anywise. For instance, in a case where the lottery data is a seven digits number, each seven digits number as a first prize and a second prize (hereinafter referred to as “winning number”) is determined beforehand by roulette or other means. The recipient sending the return email, who owns a lottery data corresponding to the winning number or a number near the winning number, receives the gift. The recipient can participate in the lottery for winning the given gift or others if he/she sends the return message can prompt the reply from user. The gift may include, not only a car and bicycle, but also digital contents such as music and moving picture, e.g., data in MP3 or MPEG format. In the case where the gift is digital contents, the relevant user can receive the gift instantaneously via the Internet or others, as well as waste of resources such as case paper is not involved, thereby contributing to environmental protection.

There will next be described further another arrangement where a recipient who sends a return email obtains a benefit associated with a ranking table which is updated in accordance with a rate of sending return email or content of return email. In this arrangement, a content of a return email is rated or evaluated by the original sender. For instance, a case where user A sends an email message asking user B “Which country do you like?” and user B sends a return email replying “Animal kingdom” will be described. When user A receives the return mail from user B, the CPU 101 operates to display a rating screen, for example, as follows: “How do you rate this message? A: Excellent, B: Not bad, C: Bad”. User A rates the return email from user B through the rating screen. In this specific example, user A is satisfied with the surrealistic reply from user B, and selects “A”.

In such a case, if acquisition points are assigned in advance such that A: five points, B: three points, and C: one point, for instance, a rating data indicative of five points acquired is sent to the server 200. The server 200 receives the rating data, and adds the points according to the rating data to relevant current points stored in the registrant DB 2021. In this case, there is provided a return-email rating field for each registrant in the registrant DB. Based on the thus counted return-email rating data, the server 200 operates to create the ranking table placing the users in the order, and periodically give notice to the registrants for the service, or update a website where the ranking table is publicized. This arrangement has the effect of enhancing competitive consciousness among the users and serves as an incentive to send a return email. Further, in a case where higher-ranking persons receive a specific favorable treatment, such as that these persons are likely to win the lottery or can obtain a secret website address, the users are further encouraged to send a return email.

In the above-described example, the server 200 selects the destination user randomly or based on the profile information. However, the user may select a destination user freely, to some extent. Such an arrangement will be described by reference to FIG. 10.

FIGS. 10 A-E show an example of display screens in a case where potential destination users are categorized by favorite pursuits, sex, region, and rate of sending return email, and rating of return email, based on the profile information of the registrants.

FIGS. 10A-C show an example of display screens in a case where a user desires to send a comment about game of Go to someone by email. In this case, the user designates to select the destination user by “category”, and thus various categories are shown on the display 102 (FIG. 10B). When “game of Go” is selected from the categories shown, nicknames or others of registrants whose profile information indicates that their favorite pursuits are game of Go are shown on the screen (FIG. 10C). In this regard, if information related to a return email, such as the rate of sending return email (a rate the user tends to send a return email when having received an email message) and rating of content of the return email, is shown on the screen, as shown in FIG. 10C, the information is conveniently referred to by the user when selecting a destination user.

At least one of the nicknames or others of the registrants as shown on the screen is selected, and then the server 200 searches for the registrant corresponding to the nickname or others in the registrant DB 2021 and forwards the email message to an address of the registrant.

Although it is not shown in FIG. 10C, a time taken by the user who has received an email message to send a return mail (which time will be referred to as “reply time”) may be shown, too. In this case, a reply time is obtained such that the server 200 stores time when the server 200 forwards an email message to the destination user, and implements processing to subtract the time from time when the return email as a reply to the email message is received by the server 200, for instance.

FIGS. 10D and 10E show an example of display screens in a case where the destination user is selected by “region”. As shown in FIG. 10E, further selection may be made from among area (e.g. “Kansai”), prefecture (e.g. “Osaka-fu”), city, town and village (e.g. “Yao-city”), and postal code. The server 200 categorizes beforehand the registrants by the area, prefecture, city, town and village, and so on, based on domicile address data stored as the profile information in the registrant DB 2021. In a case when a region where a user to be selected as the destination user is located (hereinafter referred to as “region of destination user”) is designated by a information processing apparatus, for example, the CPU 101 of the information processing apparatus sends a destination-user region data indicative of the region of destination user to the server 200. On receiving the data, the server 200 selects a destination user who falls within the category corresponding to the region indicated by the destination-user region data.

Further, in a case where an information processing apparatus is equipped with a location information detector such as a GPS unit for detecting a location information of the apparatus, a destination user may be automatically specified based on the detected location information.

In such a case, for instance, in the screen as shown in FIG. 10E, “4. Use GPS” is selected. The CPU 101 then instructs the location information detector to obtain the current location of the information processing apparatus, and specifies a region of destination user based on the detected location information and destination-user range specifying data stored in the memory 104.

The destination-user range specifying data is a data for specifying a prescribed range based on a given location point, and may represent an area of 5 km in radius, for instance. More specifically, in a case where the user goes on a journey to Osaka Castle, and “4. Use GPS” is selected there, the CPU 101 specifies an area of 5 km in radius around the Osaka Castle as the region of destination user, and sends the destination-user region data to the server 200. On receiving the destination-user region data, the server 200 determines registrants having a domicile address within the relevant area as a parent population from the registrant DB 2021, and the destination user is selected from the parent population, for instance, five destination users are selected randomly from the parent population.

According to the arrangement, the user may casually send and receive an email message to and from another user whose domicile address is near the current location of the user, and thus can communicate with another user with much affinity by engaging in an animated conversation on a zone-based local topic, for example.

It is often the case that a domicile address of a user registered in the server 200 does not coincide with the current location of the user. Therefore, it may be arranged such that the registrant DB 2021 may store not only a domicile address of a user, but also a current location data indicative of the current location of the user.

In this case, the information processing apparatus obtains the current location data indicative of the current location of the apparatus through the GPS unit or others and by implementing a predetermined operation. The information processing apparatus sends the current location data to the server 200. On receiving the current location data, the server 200 stores the current location data with associating the current location data with the domicile address data stored in the registrant DB 2021. The server 200 determines a parent population from which the destination user is selected, by referring to the domicile address data and current location data stored in the registrant DB 2021.

According to this arrangement, in a case where a user who has registered his/her domicile address in Tokyo makes a business trip to Osaka, not only the address in Tokyo but also the current location in Osaka are registered, enabling the user to receive an email message which is destined for a user of Tokyo as well as an email message destined for a user of Osaka. Thus, opportunities for communicating with others are augmented.

The arrangement where the server 200 stores both of the domicile address data and current location data as data related to location of a service registrant enriches the service.

Although the server 200 as described above is adapted to refer to both of the domicile address data and current location data, it may be arranged such that the user can instruct the server 200 to refer to only one of these data by priority, or such that a registrant can register a location data indicative of a desired location as location information related to the registrant in the registrant DB 2021, as shown in FIG. 10F. Further, it may be arranged such that a user registers a current location data, and at a later time deletes the registered current location data by him/herself. Still further, each time a current location is obtained, it may be selected by the user whether to update the current location data or not.

In the above-described example, the user informs the server 200 of the current location data or updates the current location data. This arrangement is not limitative. For instance, location information (base-station location information) indicative of location of a base station communicating with the information processing apparatus may be utilized to automatically inform the server of the current location data or update the current location data, or it may be arranged such that when the present service is used, the GPS unit or others automatically obtains location information or others of the information processing apparatus.

Although in the above description of examples, the cases where “category” and “region” are respectively selected are illustrated, it is to be understood that destination user may be selected by sex, rate of sending return mail or rating of return email.

As described above, since a plurality of items are provided in selecting a destination user, the user can enjoy the user-friendliness of selecting a desirable destination user by him/herself.

It is noted that where an email message is sent to a plurality of destination users, to distinguish the selected destination users from other users, nicknames of the selected destination users may be displayed by half-tone dot meshing or in another color different from the color of other users, or, check boxes may be used for placing a check mark for the selected destination users. According to any one of these arrangements, user-friendliness of the service is further enhanced.

In the above-described examples, each item of category or region is selected through a selection screen. However, it may be arranged such that the user can directly enter characters or data such as a category or a region through the input portion 105.

It is noted that, when the service according to each of the above-described examples is used, there is a high possibility that the number of received email messages becomes huge. For instance, in a case where one hundred messages are received at one time, the user may suffer from a momentous problem; since the communication line is overloaded as well as considerable cost is required. In view of this, there will be described an arrangement where received email messages are screened depending upon number of received email messages or category of content of email messages.

For instance, a case where it is configured such that more than five email messages related to the present service are not received will be described. The information processing apparatus 100 is equipped with a mail counter which counts the number of email messages received. It is preset that 00:00 to 24:00 defines one day, for example, and in a case where the count of the mail counter goes beyond the threshold number predetermined by the user, which is five in this example, the CPU 101 sends a mail-receipt rejection data indicative of that any email message related to the service is not to be received from then on. The server 200 which has received the mail-receipt rejection data does not forward any email message to the user's information processing apparatus after that. In this regard, the server 200 may erase the email message which is not forwarded to the information processing apparatus, or, may once store the email message and forward the email message next day. When another day starts, the CPU 101 resets the mail counter.

Screening the email messages by category is similarly implemented. For instance, a case where an email message category of which is not “baseball” is not received will be described. In this case, whether a category data related to the received email message is baseball or not is determined by the server 200, which does not forward an email message category of which is not baseball. The number of received email messages may be limited such that email messages category of which is baseball are received up to five, i.e., the threshold of number and category of content may be employed in combination to limit the number of received email messages.

Accordingly, the problem that the number of received email messages becomes huge does not occur even if the present service is used, which is convenient for the users.

The above-described functionalities provided by the information processing apparatus and server 200 may be performed by software. For instance, the server 200 is connected to a recording medium or the Internet and receives the relevant software from the recording medium or the Internet, to perform the functionalities. The recording media includes, for example, a floppy disk, a flexible disk, hard disk, magnetic disk, magnetic tape, any other magnetic medium, a CD-ROM, DVD, any other optical medium, a RAM, a PROM, and EPROM, a FLASH-EPROM, any other memory chip or cartridge, a carrier wave transporting data or instructions. According to this arrangement, merely a minimal essential functionality is provides on the information processing apparatus or server, and it is made easy to add, delete and update various functionalities, as desired.

It is noted that it is for protection of privacy that an email address of a user is concealed and the registrant is displayed in his/her nickname or others. Hence, in a case where the user does not mind disclosing his/her email address, the email address may not be concealed.

Further, although in each of the above-described examples, the server has the database memory, the database memory may be incorporated in the memory of the information processing apparatus. In such a case, a destination user is specified in the information processing apparatus depending upon a content of received information such as an email message. In this regard, field “interest” is provided as an item of an address book, and the CPU 102 implements processing to select the destination user based on a data registered in the “interest” field and the database stored in the memory 104. According to this arrangement, processing implemented by the server can be reduced.

It is to be understood that the features of the respective examples described above may be combined.

The present invention is not limited to details of the above-indicated examples, but the principles and new features disclosed herein cover a wide technical scope. For instance, the block diagrams, flowcharts, examples of display screens and others are shown for illustrative purposes only to describe the examples, and therefore disclosure therein does not limit the scope of the invention.

1. A method of processing information, comprising steps of:
maintaining a database storing user data regarding individuals registered as users of an information transmitting or receiving service;
receiving information from a first one of the registered users;
selecting a second user of the registered users based on the user data; and
transmitting the received information to the selected second one of the registered users.

2. The method according to claim 1, further comprising the step of receiving a category data related to a category of the information,
wherein the second user is selected based on the category data and the user data from the first user.

3. The method according to claim 1, further comprising the step of receiving a criterion data for selecting a recipient of the received information,
wherein the second user is selected so that the user data of the second user satisfies the criterion data.

4. The method according to claim 1, wherein the user data includes demographic data of the registered users.

5. The method according to claim 1, wherein the received information does not include identification information related to the second user.

6. The method according to claim 1, wherein identification information related to the first user is concealed when the information is transmitted to the second user.

7. The method according to claim 5, wherein the identification information is a network address of the first user.

8. The method according to claim 1, further comprising the step of storing an advertisement data or a questionnaire data;
wherein the user data includes a data indicating whether the registered users request viewing an advertisement or answering a questionnaire, the stored advertisement data or the stored questionnaire data is transmitted to the second user with the received information when the user data of the second user includes the data indicating that the second user requests viewing an advertisement or answering a questionnaire.

9. The method according to claim 1, further comprising the step of receiving an advertisement data or a questionnaire data;
wherein the user data includes a data indicating whether the registered users request viewing an advertisement or answering a questionnaire, the received advertisement data or the received questionnaire data is transmitted to the second user with the received information when the user data of the second user includes the data indicating that the second user requests viewing an advertisement or answering a questionnaire.

10. The method according to claim 1, further comprising the step of receiving a destination number indicating a number of the second user,
wherein one or more second users are selected based on the destination number and the user data.

11. The method according to claim 1, further comprising the step of acquiring a location data related to the first user,
wherein the second user is selected based on the location data and the user data.

12. The method according to claim 1, wherein the user data includes location data related to the registered users.

13. A server comprising:
a memory which stores user data regarding individuals registered as users of an information transmitting or receiving service;
a communication interface which receives information from a first one of the registered users; and
a selector which selects a second user of the registered users based on the user data;
wherein the communication interface transmits the received information to the selected second one of the registered users.

14. The server according to claim 13, wherein the communication interface receives a category data related to a category of the information received from the first user, and the selector selects the second user based on the category data and the user data.

15. The server according to claim 13, wherein the communication interface receives a criterion data for selecting a recipient of the received information, and the second user is selected so that the user data of the second user satisfies the criterion data.

16. The server according to claim 13, wherein the user data includes demographic data of the registered users.

17. The server according to claim 13, wherein the received information does not include identification information related to the second user.

18. An information processing apparatus comprising:
an input unit for input a number which indicates a number of destination users; and
a transmitter which transmits information and the number to a server for selecting a recipient and sending the information to the selected recipient;
wherein the information does not include identification information of any specific destination user.

19. The information processing apparatus according to claim 18, further comprising:
a picture interface which inputs picture information into the information processing apparatus; and
a picture recognizer which recognizes a string of one or more characters from the picture information;
wherein the information includes the string of one or more characters recognized by the picture recognizer.

20. The information processing apparatus according to claim 18, wherein the identification information is a network address.

21. A software product comprising executable programming code, wherein execution of the programming code causes an information processing apparatus to implement a series of steps, comprising:
storing user data regarding individuals registered as users of an information transmitting or receiving service;
receiving information from a first one of the registered users;
selecting a second user of the registered users based on the user data; and
transmitting the received information to the selected second one of the registered users.

22. The software product according to claim 21, wherein the series of steps further comprises the step of receiving a category data related to a category of the information,
wherein the second user is selected based on the category data and the user data.

23. The software product according to claim 21, wherein the series of steps further comprises the step of receiving a criterion data for selecting a recipient of the received information,
wherein the second user is selected so that the user data of the second user satisfies the criterion data.

24. The software product according to claim 21, wherein the user data includes demographic data of the registered users.
